(19) United States
(12) Patent Application Publication
(10) Pub. No.: US 2026/0264421 A1
(43) Pub. Date: Sep. 10, 2026

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventors: WATARU SUZUKI, Tokyo (JP); KEN ISHII, Kanagawa (JP)

(21) Appl. No.: 19/558,099

(22) Filed: Mar. 5, 2026

(30) Foreign Application Priority Data
Mar. 6, 2025 (JP) 2025-035855

(51) Int. Cl. B41J 11/00; B41J 15/04; G01N 29/04

(52) U.S. Cl. CPC B41J 11/009; B41J 11/0095; B41J 15/04; G01N 29/04

(57) ABSTRACT

An information processing apparatus conveys a recording medium, obtains information on the recording medium from the recording medium to be conveyed, sets a target region of the recording medium for obtaining the information from the recording medium when obtaining the information, and estimates a type of the recording medium based on the information obtained from the target region of the recording medium. In setting of the target region, the information processing apparatus determines a distance for conveying the recording medium to set, as the target region, a region in which a part of a surface of the recording medium is avoided, and in obtaining of the information, the information processing apparatus obtains the information from the target region that is set.

### BACKGROUND

### Field of the Technology

The present disclosure relates to an information processing apparatus, a method of controlling the same, and a storage medium.

### Description of the Related Art

In the commercial and industrial printing market, the applications of printed materials are diverse, such as CAD line drawings, posters, art works, and signage. Therefore, recording media having a wide variety of characteristics suitable for those applications are used. As the number of types of recording medium increases, the work of selecting the type of recording medium to be fed to a recording apparatus becomes complicated. Recent recording apparatuses are being equipped with a function of improving usability by automatically distinguishing the type of the fed recording medium. When the type of the recording medium is automatically distinguished, the surface property of the recording medium is an important index. The surface property of the recording medium can be derived by obtaining image data of the surface of the recording medium by an image reader and analyzing the image data. Therefore, in a case where an abnormality has occurred in the image reader or the recording medium, the surface property of the recording medium cannot be correctly derived, and there is a possibility that erroneous distinction of the type of the recording medium is caused.

Japanese Patent Laid-Open No. 2022-58434 describes a method of distinguishing a type of a recording medium by using a learned model that has performed machine learning using supervisory data in which at least one of reflectance and transmittance of the recording medium and image data obtained by capturing a surface of the recording medium and the type of the recording medium is associated.

In the recording medium before being fed to the apparatus, there is a possibility that adhesion of dirt or generation of scratches occurs on the surface of the recording medium. If the type of recording medium is distinguished based on image data obtained from the surface of the recording medium having such an abnormality, there is a possibility of erroneous determination. However, in the known technique described above, no consideration is taken at all to handling such a situation.

### SUMMARY

Embodiments of the present disclosure eliminate the above-mentioned issues with conventional technology.

A feature of embodiments of the present disclosure is to provide a technique of defining, as a target region, a region excluding a region where there is a possibility that an abnormality has occurred on the surface of a recording medium and obtaining a type of the recording medium based on information obtained from the target region.

According to embodiments of the present disclosure, there is provided an information processing apparatus comprising: one or more controllers including one or more processors in communication with one or more memories, the one or more controllers configured to: convey a recording medium; obtain information on the recording medium from the recording medium to be conveyed; set a target region of the recording medium for obtaining the information from the recording medium when obtaining the information; and estimate a type of the recording medium based on the information obtained from the target region of the recording medium, wherein in the target region setting, the one or more controllers determine a distance for conveying the recording medium to set, as the target region, a region in which a part of a surface of the recording medium is avoided, and wherein in obtaining of the information, the one or more controllers obtain the information from the target region that is set.

Further features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a perspective view illustrating an example of a recording apparatus that executes industrial and commercial printing according to an embodiment of the present disclosure.

FIG. 2 depicts a cross-sectional view illustrating an example of a main part of the recording apparatus according to the embodiment.

FIG. 3 is a block diagram for describing an example of a hardware configuration of the recording apparatus according to the embodiment.

FIG. 4 depicts a cross-sectional view illustrating a configuration example of a media sensor according to the embodiment and a periphery thereof.

FIG. 5 is a flowchart for describing an example of processing of estimating the type of a sheet S in the recording apparatus according to the embodiment.

FIGS. 6A and 6B depict views illustrating an example of image data of the surface of the sheet S obtained using a CIS.

FIGS. 7A and 7B depict views illustrating an example of an electrical signal of an ultrasonic wave transmitted through the sheet S obtained using an ultrasonic wave transmitter and a microphone.

FIG. 8A is a flowchart for describing details of the processing in step S501 of FIG. 5 according to the embodiment.

FIG. 8B is a sub-flowchart for describing details of step S501 in a case of using an outer diameter detection sensor of a roll sheet R according to another embodiment.

FIG. 9A is a flowchart for describing processing of obtaining a characteristic value in step S503 according to the embodiment.

FIG. 9B is a flowchart for describing processing of estimating the type of the recording medium in step S504 according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

First, terms used in the present embodiment are defined as follows in advance.
“Recording”

In this description, “recording” is not limited to a case of forming significant information such as characters and figures. The form of recording has nothing to do with whether it is meaningful or meaningless, or whether it is manifested in a manner visually perceivable by a human. Recording is intended to represent formation of an image, a design, a pattern, or the like on a recording medium, or processing a medium in a broad sense.
“Recording Medium”

The recording medium is intended to represent not only paper to be used in a general recording apparatus but also a wide range of media that can receive ink, such as cloth, plastic film, metal plate, glass, ceramics, wood, and leather. In the embodiment, a roll sheet is assumed as a sheet, but cut paper, cloth, plastic film, or the like may be used.
“Ink”

The ink should be broadly interpreted similarly to the definition of “recording”, and is intended to represent a medium including a recording material that, when applied on a recording medium, can be used for formation of an image, a design, a pattern, or the like, processing of the recording medium, or processing of the ink. The physical state of the ink is liquid.
“Scan”

In order to perform recording on a recording medium, a recording head scans over the recording medium and performs recording. Here, head movement for recording or during acceleration/deceleration of the head related to recording is described as a scan.

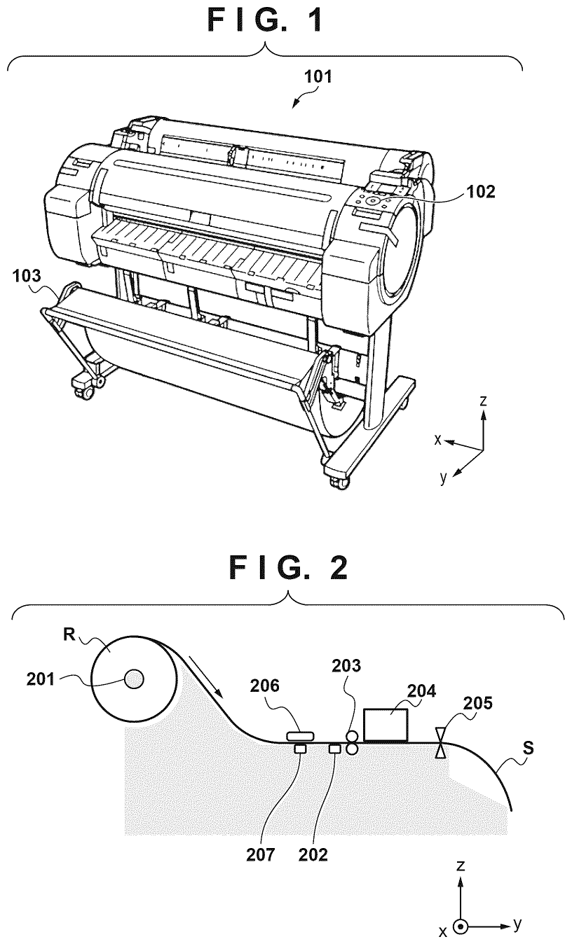

FIG. 1 depicts a perspective view illustrating an example of a recording apparatus 101 that executes industrial and commercial printing according to an embodiment of the present disclosure.

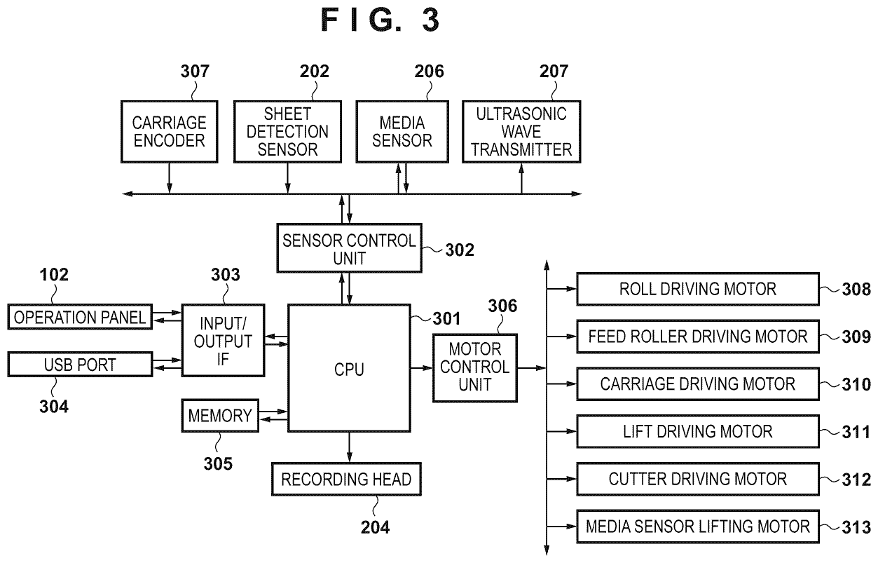

FIG. 2 depicts a cross-sectional view illustrating an example of a main part of the recording apparatus 101 according to the embodiment.

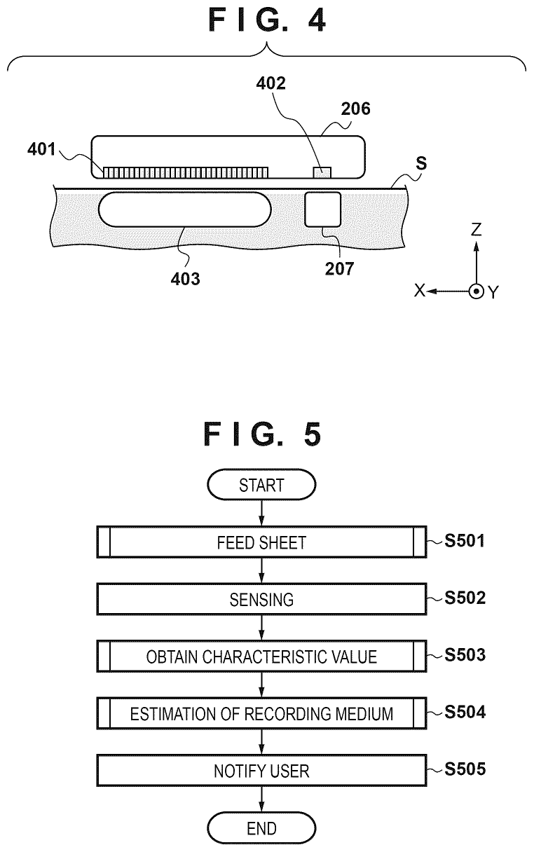

FIG. 3 is a block diagram for describing an example of a hardware configuration of the recording apparatus 101 according to the embodiment. Hereinafter, with reference to FIGS. 1 to 3, the recording apparatus 101 will be described as an example of an information processing apparatus according to the present disclosure. Note that the information processing apparatus according to the present disclosure is not limited to the recording apparatus 101 according to the embodiment. The information processing apparatus may be, for example, a server (e.g., a cloud server) or the like that can exchange various types of data with the recording apparatus 101.

In FIGS. 1 and 2, the conveyance direction in which the sheet S is conveyed by the recording apparatus 101 is defined as a +Y direction, and the direction in which a recording head 204 ejects ink onto the sheet S is defined as a −Z direction. The scanning direction in which the recording head 204 can move (scan) is defined as a ±X direction.

As illustrated in FIG. 2, the recording apparatus 101 rotatably holds the roll sheet R in which the sheet S is wound in a roll shape. By rotating the roll sheet R by a roll driving motor, the sheet S is supplied from the roll sheet R to a feed roller 203. The feed roller 203 conveys the sheet S by rotating while nipping the sheet S. Then, the feed roller 203 is rotated by a feed roller driving motor 309 (FIG. 3), whereby the sheet S is conveyed to a position where the recording head 204 is able to perform recording. The recording head 204 is mounted on a carriage (not illustrated) and is configured to reciprocate in the ±X direction. The recording head 204 records an image by ejecting ink onto the sheet S that is conveyed while moving in the ±X direction. The sheet S on which the image is recorded in this manner is discharged from a discharge portion present on a downstream side of the recording head 204 in the conveyance direction of the sheet S, and is stacked on a basket 103.

An operation panel 102 is a user interface (UI) module that accepts various operations from a user. The user can perform various settings for the recording apparatus 101 using various switches, a touch panel, or the like included in the operation panel 102.

In the conveyance direction of the sheet S, a sheet detection sensor 202 is disposed in a conveyance path upstream of the feed roller 203. When the sheet S is supplied from the roll sheet R by the user and the sheet detection sensor 202 detects the sheet S, a conveyance operation of the sheet S by the feed roller 203 is started. The conveyance of the sheet S is executed by a roll driving motor 308 (FIG. 3) and the feed roller driving motor 309 rotating in synchronization. At this time, the type of the sheet S can be estimated by estimation of the sheet type described later. The various settings for the recording apparatus 101 are, for example, settings of the size and type of the sheet S. The operation panel 102 is further used to display an estimation result of the sheet type described later.

In the conveyance direction of the sheet S, a media sensor (sensor unit) 206 and an ultrasonic wave transmitter 207 are disposed on the upstream side of the sheet detection sensor 202. The media sensor 206 is disposed above the sheet S with respect to the gravity direction (Z direction), and the ultrasonic wave transmitter 207 is disposed below the sheet S with respect to the gravity direction. The media sensor 206 and the ultrasonic wave transmitter 207 are used to estimate the type of sheet described later.

To record an image on the sheet S, a conveyance operation of conveying the sheet S to a position facing the recording head 204 is executed first. Next, a recording operation of scanning the recording head 204 in an intersecting (+X direction) direction intersecting (orthogonal to) the conveyance direction of the sheet S while ejecting the ink is executed. By alternately executing the conveyance operation of the sheet S and the recording operation of the image, a desired image is recorded on the sheet S. The sheet S on which the image is recorded in this manner is sequentially conveyed to the downstream side of the recording head 204 in the conveyance direction of the sheet S. The sheet S conveyed in this manner is cut into a designated size by a cutter 205 included in the discharge portion, and the sheet S that is cut is stacked on the basket 103.

As illustrated in FIG. 3, the recording apparatus 101 includes the operation panel 102, the recording head 204, a CPU 301, a sensor control unit 302, and an input/output interface (IF) 303. The recording apparatus 101 also includes a USB port 304, a memory 305, and a motor control unit 306. The recording apparatus 101 also includes the sheet detection sensor 202, the media sensor 206, the ultrasonic wave transmitter 207, and a carriage encoder 307. The recording apparatus 101 also includes the roll driving motor 308, the feed roller driving motor 309, a carriage driving motor 310, a lift driving motor 311, a cutter driving motor 312, and a media sensor lifting motor 313. The memory 305 includes a ROM and a RAM, and the ROM stores programs and various types of data. The RAM is used as a deployment area of a program executed by the CPU 301 and a work area in which the CPU 301 temporarily stores various types of data during processing.

The motor control unit 306 controls each driving motor in accordance with an instruction from the CPU 301 operating in accordance with a program stored in the memory 305. The roll driving motor 308 rotates a spool 201 (FIG. 2) of a holder that holds the roll sheet R, and conveys the sheet S from the roll sheet R in the conveyance direction. The feed roller driving motor 309 rotates the feed roller 203 to convey the sheet S to the position facing the recording head 204. The feed roller driving motor 309 is provided with an encoder (not illustrated) for detecting the conveyance amount of the sheet S. The CPU 301 is able to detect the conveyance amount of the sheet S by obtaining the rotation amount of this encoder.

The carriage driving motor 310 can move the carriage and the recording head 204 mounted thereon by rotating a carriage belt (not illustrated) connected to the carriage (not illustrated) on which the recording head 204 is mounted. The lift driving motor 311 moves the carriage and the recording head 204 up and down. The cutter driving motor 312 drives the cutter 205. The media sensor lifting motor 313 lifts and lowers the media sensor 206 in the Z direction.

Various pieces of setting information and the like based on a user operation from a PC or the like connected via the operation panel 102 or the USB port 304 are input to the CPU 301 via the input/output IF 303. Those pieces of information that are input are stored in the memory 305. The CPU 301 can read, as necessary, the information stored in the memory 305, and execute various types of processing in accordance with the information. That is, the CPU 301 functions as processing modules that execute various types of processing.

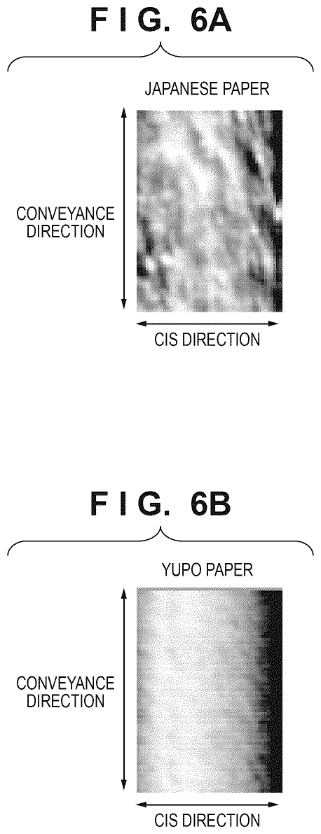

The CPU 301 controls the carriage encoder 307, the sheet detection sensor 202, a contact image sensor (CIS) 401 (FIG. 4), a microphone 402 (FIG. 4), and the ultrasonic wave transmitter 207 via the sensor control unit 302, and obtains various types of information. That is, the CPU 301 executes various types of control based on input information from the carriage encoder 307, the sheet detection sensor 202, the CIS 401, and the microphone 402. Note that the CIS 401 and the microphone 402 are included in the media sensor 206, and therefore omitted in FIG. 3. The CPU 301 controls the carriage encoder 307, the sheet detection sensor 202, the media sensor 206, and the ultrasonic wave transmitter 207 via the sensor control unit 302 to obtain information from them. The CPU 301 executes various types of control based on input information from the carriage encoder 307, the sheet detection sensor 202, and the media sensor 206. The RAM of the memory 305 is used as a temporary work region.

Next, the processing of estimating the type of the sheet S executed by the CPU 301 according to the embodiment will be described with reference to FIGS. 4 to 6.

FIG. 4 depicts a cross-sectional view illustrating a configuration example of the media sensor 206 according to the embodiment and a periphery thereof.

As illustrated in FIG. 4, the media sensor 206 includes the CIS 401 and the microphone 402. A roller 403 is disposed at a location facing the CIS 401. The ultrasonic wave transmitter 207 is disposed at a location facing the microphone 402.

Here, the CPU 301 brings the media sensor 206 into contact with the sheet S by lowering the media sensor 206 in the −Z direction by the media sensor lifting motor 313, and nips the sheet S using the CIS 401 and the roller 403. By nipping the sheet S in this manner, it is possible to stably obtain image data of the surface of the sheet S and measure the characteristics thereof. The CPU 301 optically reads the surface of the sheet S by the CIS 401 while conveying the sheet S in a state where the sheet S is nipped between the CIS 401 and the roller 403 to obtain the image data of the surface. Then, when the reading of the sheet S ends, the CPU 301 raises the media sensor 206 in the Z direction by the media sensor lifting motor 313, thereby separating the media sensor 206 from the sheet S.

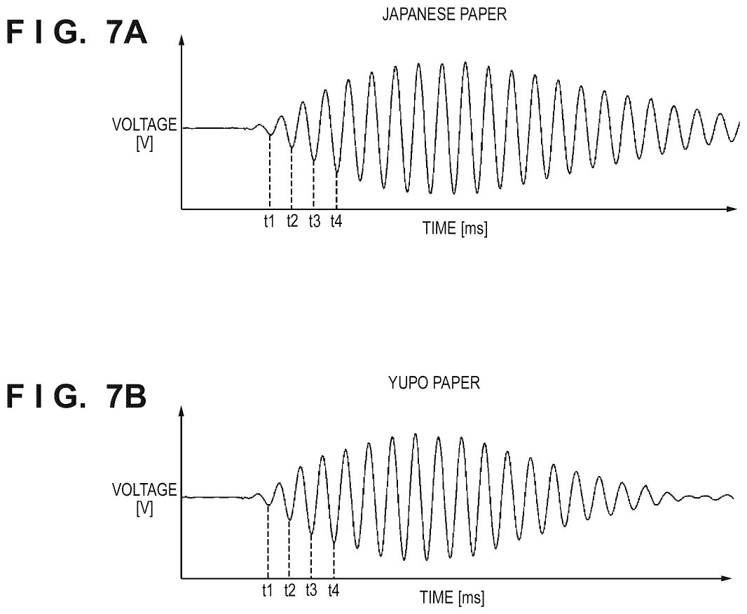

FIG. 5 is a flowchart for describing an example of processing of estimating the type of the sheet S in the recording apparatus 101 according to the embodiment. The processing shown in this flowchart is implemented by the CPU 301 of the recording apparatus 101 deploying a program stored in the memory 305 into the RAM and executing it. Note that some or all of the functions of the steps in FIG. 5 may be implemented by hardware such as an ASIC or an electronic circuit. The symbol “S” in the description of each processing means a step in the flowchart. The processing shown in FIG. 5 may be started, for example, when the user sets the roll sheet R in the recording apparatus 101. Alternatively, after the user sets the roll sheet R in the recording apparatus 101, the processing may be started in response to detecting that a predetermined operation by the user is input on the operation panel 102. For example, the operation panel 102 may be provided with a feed button, and may be started in response to the user pressing the feed button.

First, in step S501, the CPU 301 feeds the sheet S. Details of this processing in step S501 will be described later. Next, the processing proceeds to step S502 and the CPU 301 performs sensing. That is, by controlling the media sensor 206 and the ultrasonic wave transmitter 207 via the sensor control unit 302, the CPU 301 measures surface information and cross section information of the sheet S, and stores the measured information in the memory 305.

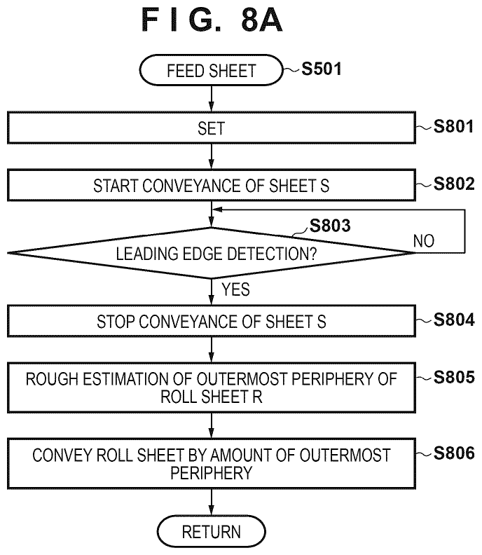

FIGS. 6A and 6B depict views illustrating an example of image data of the surface of the sheet S obtained using the CIS 401.

FIG. 6A illustrates an example of image data of a surface when the sheet S is Japanese paper, and FIG. 6B illustrates an example of image data of a surface when the sheet S is Yupo paper. Yupo paper is a synthetic paper having features of paper and a plastic film.

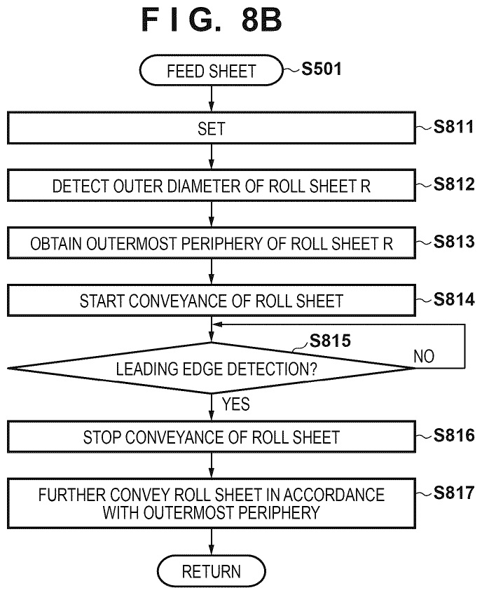

FIGS. 7A and 7B depict views illustrating an example of an electrical signal of an ultrasonic wave transmitted through the sheet S obtained using the ultrasonic wave transmitter 207 and the microphone 402. FIG. 7A illustrates an example of an electrical signal of an ultrasonic wave when the sheet S is Japanese paper, and FIG. 7B illustrates an example of an electrical signal of an ultrasonic wave when the sheet S is Yupo paper.

The CIS 401 is a line sensor extending in the width direction of the sheet S, and obtains one-dimensional (one row) image data. The CPU 301 obtains the image data of the surface of the sheet S using the CIS 401 while conveying the sheet S by driving the roll driving motor 308 and the feed roller driving motor 309 in synchronization in a state where the sheet S is nipped using the CIS 401 and the roller 403. By reading the surface of the sheet S by the CIS 401 while conveying the sheet S in this manner, it is possible to obtain two-dimensional image data as illustrated in FIG. 6A or 6B, for example. In FIGS. 6A and 6B, the CIS direction corresponds to the width of the CIS 401 (the width in the X direction intersecting the sheet S), and the conveyance direction corresponds to the conveyance amount of the sheet S measured by the CIS 401. Note that although an example of measuring using a one-dimensional sensor as the CIS 401 is presented here, the surface of the sheet S may be measured using a two-dimensional sensor.

When the surface of the sheet S is measured by the CIS 401, an electrical signal (cross section information) of an ultrasonic wave illustrated in FIG. 7A or FIG. 7B, for example, is obtained by the ultrasonic wave transmitter 207 and the microphone 402 (sound capturing sensor). In the embodiment, an example of obtaining an electrical signal of an ultrasonic wave together with the measurement of the surface of the sheet S by the CIS 401 will be described, but the present disclosure is not limited to this. For example, the measurement of the surface of the sheet S and the obtainment of the electrical signal of the ultrasonic wave passing through the sheet S may be performed separately. The electrical signal of the ultrasonic wave may be obtained in a state where the sheet S is not conveyed.

In the embodiment, the obtainment of the image data of the surface of the sheet S by the CIS 401 described above and the obtainment of the electrical signal of the ultrasonic wave transmitted through the sheet S by the ultrasonic wave transmitter 207 and the microphone 402 are repeatedly performed. In this manner, the image data of the surface of the sheet S obtained a plurality of times and the electrical signal of the ultrasonic wave transmitted through the sheet S are obtained and stored in the memory 305. Thereafter, the processing proceeds to step S503.

In step S503, the CPU 301 derives a characteristic value of the sheet S. That is, by using the method of deriving the feature amount stored in the memory 305 in advance, the CPU 301 derives the feature amount regarding the image data (surface information) of the surface of the sheet S and the feature amount regarding the cross section information. The feature amount regarding the surface information of the sheet S is derived from the image data of the surface of the sheet S obtained in step S502 described above. The feature amount regarding the cross section information of the sheet S is derived from the electrical signal of the ultrasonic wave transmitted through the sheet S obtained in step S502 described above.

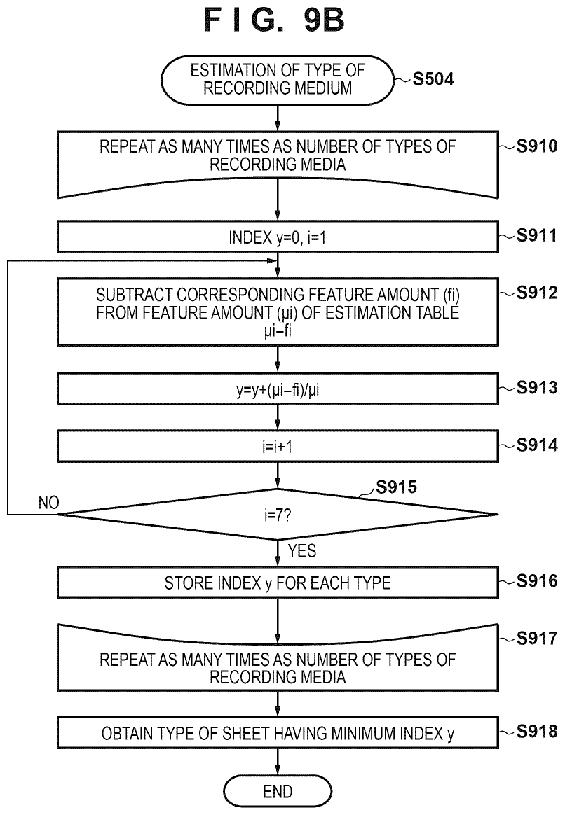

FIG. 9A is a flowchart for describing processing of obtaining a characteristic value in step S503.

Here, first, the CPU 301 derives four feature amounts regarding the surface information of the sheet S from the image data of the surface of the sheet S as illustrated in FIG. 6A or 6B, for example. First, in step S901, the CPU 301 obtains the luminance of the image data of the surface of the sheet S as a first feature amount (feature amount 1). Here, the luminance is derived as an average value of all pixel values of the image data.

Next, the processing proceeds to step S902 and the CPU 301 obtains peak-to-peak of the entire image of the surface of the sheet S as a second feature amount (feature amount 2). This peak-to-peak of the entire image is derived as a difference between the maximum pixel value and the minimum pixel value in the image.

Next, the processing proceeds to step S903 and the CPU 301 obtains peak-to-peak in the CIS direction as a third feature amount (feature amount 3). The peak-to-peak in the CIS direction is derived as an average value of differences between the maximum pixel value and the minimum pixel value in each row of pixels arranged in the CIS direction.

Next, the processing proceeds to step S904 and the CPU 301 obtains peak-to-peak in the conveyance direction of the sheet S as a fourth feature amount (feature amount 4). The peak-to-peak in the conveyance direction is derived as an average value of differences between the maximum pixel value and the minimum pixel value in each column of pixels arranged in the conveyance direction.

In this manner, the above-described four feature amounts are derived based on the image data of the surface of the sheet S obtained by the CIS 401 and stored in the memory 305 in step S502. Average values of the respective feature amounts are derived, and they are set as final feature amounts (f1 to f4) of the sheet S. Note that although the four feature amounts have been described as the surface information of the sheet S here, the present disclosure is not limited to this, and for example, the roughness of the surface of the sheet S, various statistics, and the like may be used.

Next, the processing proceeds to step S905 and the CPU 301 derives three feature amounts regarding the cross section information of the sheet S from electrical signals of the ultrasonic wave transmitted through the sheet S as illustrated in FIGS. 7A and 7B, for example.

Specifically, the CPU 301 obtains peak 1 as a fifth feature amount (feature amount 5). This peak 1 is derived as a maximum voltage value in the period from time t1 to time t2 in FIGS. 7A and 7B. Next, peak 2 is obtained as a sixth feature amount (feature amount 6). This peak 2 is derived as a maximum voltage value in the period from time t2 to time t3. Furthermore, peak 3 is obtained as a seventh feature amount (feature amount 7). This peak 3 is derived as a maximum voltage value in the period from time t3 to time t4.

In this manner, the above-described three feature amounts (feature amount 5 to feature amount 7 (f5 to f7)) are derived based on electrical signals of the ultrasonic wave transmitted through the sheet S obtained by the ultrasonic wave transmitter 207 and the microphone 402 and stored in the memory 305. An average value of the respective feature amounts may be derived and used as the final feature amount of the sheet S. Note that here, the feature amounts 5 to 7 are obtained by the maximum voltage value, but may be a minimum voltage value, for example. Note that the cross section information of the sheet S obtained here corresponds to information such as the thickness and basis weight of the sheet.

Next, the processing proceeds to step S906 and the CPU 301 stores, in the memory 305, the seven feature amounts (f1 to f7) based on the image data of the surface of the sheet S and the cross section information obtained in steps S901 to S905. The above is the description of the processing of obtaining the characteristic value in step S503.

Next, the processing proceeds to step S504 and the CPU 301 estimates the type of the sheet S. That is, the CPU 301 estimates the type of the sheet S from the seven feature amounts (f1 to f7) obtained in step S503 described above using an estimation table stored in the memory 305 in advance. Note that in the embodiment, an example in which the estimation table is stored in the memory 305 will be described, but the estimation table may be stored outside the recording apparatus 101, and the recording apparatus 101 may obtain the estimation table from the outside to execute the processing described later.

FIG. 9B is a flowchart for describing the processing of estimating the type of the recording medium in step S504.

Here, between step S910 and step S917, the processing in steps S911 to S916 is repeatedly executed as many times as the number of types of recording media that are targets to be estimated. For example, in the present embodiment, “plain paper”, “glossy paper”, “half-glossy paper”, and “glossy film” are assumed as the type of the sheet S, and therefore the processing is executed with these four types as targets.

First, in step S911, the CPU 301 initializes an index y provided in the memory 305 to 0 and a variable i to 1. Next, the processing proceeds to step S912 and the CPU 301 subtracts the feature amount (ﬁ) of the sheet S from a value (μi) in the estimation table corresponding to the type of the recording medium, for example, “plain paper”. At this time, since the value of i is 1 at the beginning, (μ1-f1) is obtained, and in step S913, the CPU 301 obtains (μ1-f1)/μl and adds it to the index y. Next, the processing proceeds to step S914, and the CPU 301 increments the variable i by 1, and the processing proceeds to step S915. Here, since there are seven feature amounts, the CPU 301 determines whether the variable i has become 7, and, if the variable i=7 is not true, the processing proceeds to step S912. Next, in step S912, the CPU 301 subtracts the feature amount (f2) of the sheet S described above from a value (μ2) of the estimation table. In this manner, (μ2-f2)/μ2 is obtained and added to the index y in step S913. When the processing corresponding to the number of feature amounts (here, 7) ends in step S915 in this manner, the processing proceeds to step S916 and the CPU 301 can store, in the memory 305, the index y (plain) corresponding to the recording medium corresponding to “plain paper”. Then, the processing proceeds to step S911 and the CPU 301 executes the above-described processing from the value (μi) of the estimation table corresponding to the next type “glossy paper” of the recording medium. In this manner, the processing for the four types is executed in steps S911 to S916.

Here, the index y indicates a total value of differences between the values (μi) of the estimation table corresponding to the type of the recording medium and the actually measured feature amounts of the sheet S. Therefore, the type of the recording medium having the smallest total value is closest to the type of the sheet S actually measured.

The calculation of the CPU 301 in step S912 and step S913 can be expressed by the following Expression (1).

$$y = {\sum }_{i = 1}^{i = 7} \{ ( μ i - fi ) / μ i \} \qquad Expression ( 1 )$$

Here, the index y is a total sum of values in which each feature amount of the sheet S derived in step S503 is subtracted from the average value of each feature amount corresponding to the type of an arbitrary sheet S recorded in the estimation table in advance, and then the difference is divided by the average value, and is a value for estimating the type of the sheet S. μ1 to μ7 are the seven feature amounts corresponding to the type of the sheet S recorded in the estimation table in advance. Specifically, μ1 to μ7 are feature amounts corresponding to the luminance, the peak-to-peak of the entire image, the peak-to-peak in the CIS direction, the peak-to-peak in the conveyance direction, peak 1, peak 2, and peak 3, respectively. There are as many combinations of these seven feature amounts as the types of sheet S. Similarly, f1 to f7 are seven feature amounts derived in step S503. Specifically, f1 to f7 are feature amounts corresponding to the luminance, the peak-to-peak of the entire image, the peak-to-peak in the CIS direction, the peak-to-peak in the conveyance direction, peak 1, peak 2, and peak 3, respectively, when the sheet S is measured.

That is, the index y indicates an error in the feature amount of the sheet S fed in step S501 with respect to each type of the sheet S that is an estimation target recorded in the estimation table in advance. Therefore, the type of the sheet S having the smallest index y is the estimation result of the type of the sheet S. The index y described above is calculated for each type of the sheet S recorded in the estimation table. Then, the type of the sheet S having the smallest index y is defined as the type of the sheet S fed in step S501.

Note that in a case where the type of the recording medium is estimated using only the three feature amounts (μ5 to μ7) regarding the cross section information of the sheet S, the following Expression (2) may be executed in step S912 and step S913.

$$y = {\sum }_{i = 5}^{i = 7} \{ ( μ i - fi ) / μ i \} \qquad Expression ( 2 )$$

Alternatively, in a case where the type of the recording medium is estimated using only the four feature amounts (μ1 to μ4) regarding the surface information of the sheet S, the following Expression (3) may be executed in step S912 and step S913.

$$y = {\sum }_{i = 1}^{i = 4} \{ ( μ i - fi ) / μ i \} \qquad Expression ( 3 )$$

In the embodiment, the type of the sheet S includes “plain paper”, “glossy paper”, “half-glossy paper”, and “glossy film”, but the type of the sheet in the present disclosure is not limited to these. For example, a type of sheet in accordance with the characteristics of the recording medium may be used, such as a sheet having certain irregularity or basis weight as a first recording medium and a sheet having other irregularity or basis weight as a second recording medium.

In this manner, in the above-described example, when the processing for the four types of recording media ends, the processing proceeds to step S918 and the CPU 301 obtains the type of the recording medium having the minimum index y, estimates that the type thereof corresponds to the type of the sheet S, and stores it in the memory 305.

Returning to FIG. 5, the processing proceeds to step S505 and the CPU 301 displays the estimation result of the sheet S on the operation panel 102 via the input/output IF 303, thereby presenting it to the user.

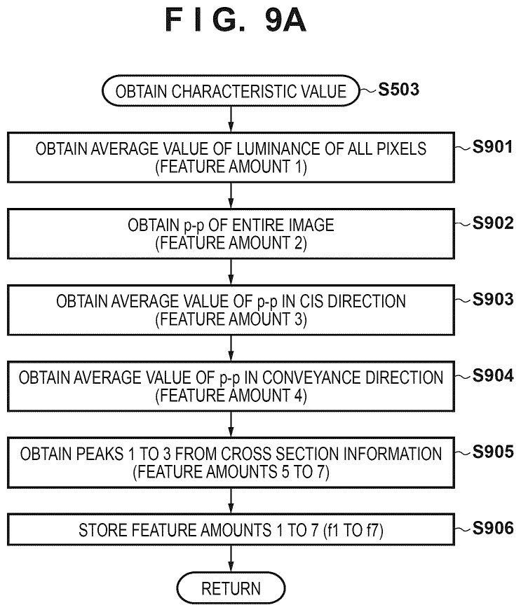

Next, the operation in step S501 of FIG. 5, which is a feature of the embodiment, will be described in detail with reference to flowcharts in FIGS. 8A and 8B and FIGS. 9A and 9B. FIGS. 8A and 8B and FIGS. 9A and 9B are flowcharts of subroutines describing different embodiments from each other, but the present disclosure is not limited to these two items of processing.

FIG. 8A is a flowchart for describing details of the processing in step S501 of FIG. 5 according to the embodiment.

In step S801, the CPU 301 detects that the roll sheet R is set in the recording apparatus 101 by the user. Next, the processing proceeds to step S802 and the CPU 301 rotates the roll sheet R by the roll driving motor 308. By this, the sheet S is supplied from the roll sheet R to the feed roller 203. Next, the processing proceeds to step S803 and the CPU 301 determines whether the sheet detection sensor 202 disposed upstream of the feed roller 203 has detected that the sheet S has reached the feed roller 203. In a case that the sheet S is not detected, the conveyance of the sheet S is continuously executed, and when the sheet detection sensor 202 detects that the sheet S has reached the feed roller 203, the processing proceeds to step S804 and the CPU 301 stops the driving of the roll driving motor 308 to stop the conveyance of the sheet S.

Next, the processing proceeds to step S805 and the CPU 301 obtains a rough estimation of the outermost periphery of the roll sheet R at this time. Here, let the distance from the position where feeding of the roll sheet R is started to the sheet detection sensor 202 be Y1, and let the rotation angle through which the roll driving motor 308 rotates during that period be θ1. Now, when the circumferential ratio is π, with a length Rout of the outermost periphery of the roll sheet R as

$$Rout = Y 1 \times 2 π / θ1 , \qquad Expression ( 3 )$$

a rough estimation of the length of the outermost periphery of the roll sheet R can be obtained. Y1 is a value unique to the recording apparatus 101, and as a method of detecting the rotation angle θ1, θ1 is obtained from a count value of an encoder of the roll driving motor 308.

Next, the processing proceeds to step S806 and the CPU 301 further conveys the roll sheet R in accordance with the outermost periphery Rout whose rough estimation is obtained.

By this processing, after the sheet S of the roll sheet R is conveyed by the amount of the outermost periphery, sensing of the sheet S is started. This makes it possible to set, as a sensing target region, the region of the sheet S excluding the outermost periphery of the roll sheet R that has a possibility that adhesion of dirt or generation of scratches occurs on the surface of the roll sheet occurs, and to solve the above-described problem.

Note that in a case where the sheet detection sensor 202 is present on a downstream side of the media sensor 206 in the conveyance direction of the sheet S by Y2, the sheet S is conveyed by an extra length (Rout-Y2). Doing this makes it possible to reliably perform estimation processing of the sheet type while avoiding the roll paper of the outermost periphery, when the media sensor 206 performs sensing.

FIG. 8B is a flowchart for describing details of step S501 in a case of using an outer diameter detection sensor of the roll sheet R according to another embodiment.

In step S811, the CPU 301 detects that the roll sheet R is set in the recording apparatus 101 by the user. Next, the processing proceeds to step S812 and the CPU 301 detects an outer diameter 2r of the roll sheet R by the outer diameter detection sensor not illustrated. This outer diameter detection sensor is a sensor that measures a distance from a predetermined position of the recording apparatus 101 to an outer peripheral surface of the roll sheet, for example.

Next, the processing proceeds to step S813 and the CPU 301 obtains the outermost periphery of the roll sheet R at this time. Here, when the circumferential ratio is π, a length Rout of the outermost periphery of the roll sheet R can be obtained by

$$Rout = 2 π r . \qquad Expression ( 4 )$$

The processing proceeds to step S814 and the CPU 301 rotates the roll sheet R by the roll driving motor 308. By this, the sheet S is supplied from the roll sheet R to the feed roller 203. Then, the processing proceeds to step S815, and the CPU 301 determines whether the sheet detection sensor 202 disposed upstream of the feed roller 203 has detected that the sheet S has reached the feed roller 203, and conveys the sheet S until a leading edge of the sheet S reaches the feed roller 203. When the leading edge of the sheet S reaches the feed roller 203, the processing proceeds to step S816 and the CPU 301 stops the driving of the feed roller 203 to stop the conveyance of the sheet S. Next, the processing proceeds to step S817 and the CPU 301 further causes the sheet to be conveyed in accordance with the outermost periphery Rout obtained in step S813.

In this manner, the sheet S is further conveyed by the length of (Rout-Y2) from the position where the leading edge of the sheet S is detected to have reached the feed roller 203 by the sheet detection sensor 202. This makes it possible to reliably set the target region while avoiding a sheet part of the outermost periphery of the roll sheet R, when the media sensor 206 performs sensing. Thereafter, the CPU 301 stops the driving of the roll driving motor 308.

In this manner, the length of the outer periphery of the roll sheet R is estimated, and after the sheet S is conveyed by the length, the sheet Sis measured. In this manner, a region in which a part (e.g., outermost periphery surface) of the surface of the sheet S is avoided can be set as a sensing target region. This makes it possible to reliably avoid, from the sensing target region, the sheet part of the outermost periphery of the roll sheet R that has a possibility of adhesion of dirt or the like to perform sensing by the media sensor 206.

### Other Examples

The embodiments described above are examples for carrying out the present disclosure, and do not limit the present disclosure. For example, the technique according to the embodiments may be applied not only to a recording apparatus that ejects ink onto a sheet to form an image, but also to a scanner that reads an image on a sheet, a post-processing machine that processes a sheet, and the like. The sheet is not limited to a roll sheet, and may be a sheet of a sheet type. In this case, by conveying the sheet so that a region close to the center portion of the paper surface becomes a sensing target region while avoiding a peripheral portion, which is highly likely to be touched by the user, similar effects to those in the case of the roll sheet are expected.

The estimation of the sheet type is not limited to that by the CPU 301 mounted on the recording apparatus 101, and may be performed by a scanner, a post-processing machine, a PC, or the like.

The feature amount of the recording medium described above is not limited to the seven of them, and for example, the color, thickness, or the like of the sheet S may be used. In the embodiment described above, an example in which the type of the sheet is estimated using all the four feature amounts based on the surface information has been described, but the present disclosure is not limited to this. For example, the type of the sheet may be estimated using at least one of the feature amounts regarding the image data of the surface of the sheet S.

In the embodiment, it has been described that the type of the sheet S is estimated from the total of seven feature amounts of the four feature amounts based on the surface information and the three feature amounts based on the cross section information, but the present disclosure is not limited to this. For example, the type of the sheet S may be estimated from at least one of the feature amounts based on the image data (surface information) of the surface of the sheet S and at least one of the feature amounts regarding the cross section information of the sheet S.

In the estimation of the outer periphery of the roll sheet R, the conveyance amount of the roll sheet R may be determined by using, in place of estimating the outer periphery, the length of the outer periphery in a case of the maximum diameter that can be mounted on the recording apparatus 101. By doing this, even in a case where the remaining amount of the roll sheet R is reduced and the length of the outermost periphery is shortened, an effect that sensing can be reliably performed while avoiding the sheet part of the outermost periphery of the roll sheet R is expected.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-035855, which was filed on Mar. 6, 2025, and which is hereby incorporated by reference herein in its entirety.

What is claimed is:

1. An information processing apparatus comprising:
one or more controllers including one or more processors in communication with one or more memories, the one or more controllers configured to:
convey a recording medium;
obtain information on the recording medium from the recording medium to be conveyed;
set a target region of the recording medium for obtaining the information from the recording medium when obtaining the information; and
estimate a type of the recording medium based on the information obtained from the target region of the recording medium,
wherein in the target region setting, the one or more controllers determine a distance for conveying the recording medium to set, as the target region, a region in which a part of a surface of the recording medium is avoided, and
wherein in obtaining of the information, the one or more controllers obtain the information from the target region that is set.

2. The information processing apparatus according to claim 1 further comprising:
a holder that holds the recording medium,
wherein the one or more controllers set the target region of the recording medium by conveying the recording medium from the holder in accordance with a distance between the holder and a position at which information on the recording medium is obtained in setting of the target region.

3. The information processing apparatus according to claim 2, wherein the one or more controllers further configured to:
detect a conveyance amount of the recording medium to be conveyed; and
detect the recording medium in a conveyance path of the recording medium to be conveyed,
wherein the one or more controllers detect a conveyance amount from when conveyance of the recording medium is started from the holder until the recording medium is detected in the conveyance path, and
set the target region of the recording medium by determining the distance for conveying the recording medium based on a distance from the holder to a position where the recording medium is detected in the conveyance path and the conveyance amount.

4. The information processing apparatus according to claim 2, wherein the recording medium is a roll-shaped recording medium, and the holder holds the roll-shaped recording medium.

5. The information processing apparatus according to claim 4, wherein the one or more controllers further configured to:
detect an outer diameter of a roll of the roll-shaped recording medium held by the holder; and
set the target region of the recording medium by determining the distance for conveying the recording medium based on the outer diameter of the recording medium that is detected.

6. The information processing apparatus according to claim 4, wherein the part of the surface of the recording medium that is avoided corresponds to a part of an outermost periphery of the roll of the roll-shaped recording medium held by the holder.

7. The information processing apparatus according to claim 1, wherein the one or more controllers obtain the information on the recording medium using a sensor unit including an image sensor that optically reads the surface of the recording medium,
wherein the one or more controllers move the sensor unit to a state of being in contact with the recording medium and a state of being separated from the recording medium, and
wherein the one or more controllers obtain the information from the target region by bringing the sensor unit into the state of being in contact with the recording medium when obtaining the information.

8. The information processing apparatus according to claim 7, wherein the sensor unit further includes a sensor that detects an electrical signal of an ultrasonic wave passing through the recording medium, and
wherein in obtaining of the information, the one or more controllers obtain the information on the recording medium based on the electrical signal of the ultrasonic wave detected by the sensor in a state where the sensor unit is brought into contact with the recording medium.

9. The information processing apparatus according to claim 1, wherein in the estimation of the type of the recording medium, a difference between a feature amount of the information that is obtained and a feature amount corresponding to the type of the recording medium is obtained, and the type in a case where the difference becomes minimum is estimated as the type of the recording medium.

10. A method of controlling an information processing apparatus, the method comprising:
conveying a recording medium;
obtaining, by a sensor unit, information on the recording medium from the recording medium conveyed in the conveyance;
setting, by the sensor unit, a target region of the recording medium for obtaining the information from the recording medium; and
estimating a type of the recording medium based on the information obtained from the target region of the recording medium,
wherein in the setting, a region in which a part of a surface of the recording medium is avoided is set as the target region by determining a distance for conveying the recording medium, and
wherein in the obtaining, the information is obtained from the target region that is set.

11. The method of controlling according to claim 10, wherein in the setting, the target region of the recording medium is set for the sensor unit by conveying the recording medium from a holder in accordance with a distance between the holder that holds the recording medium and the sensor unit.

12. The method of controlling according to claim 11 further comprising:
detecting a conveyance amount of the recording medium to be conveyed; and
detecting the recording medium in a conveyance path of the recording medium to be conveyed,
wherein a conveyance amount from when conveyance of the recording medium is started from the holder until the recording medium is detected in the conveyance path is detected, and
wherein the target region of the recording medium is set by determining the distance for conveying the recording medium based on a distance from the holder to a position where the recording medium is detected in the conveyance path and the conveyance amount.

13. The method of controlling according to claim 11, wherein the recording medium is a roll-shaped recording medium, and the holder holds the roll-shaped recording medium.

14. The method of controlling according to claim 13 further comprising:
detecting an outer diameter of a roll of the roll-shaped recording medium held by the holder,
wherein in the setting, the target region of the recording medium is set by determining the distance for conveying the recording medium based on the outer diameter of the recording medium that is detected.

15. The method of controlling according to claim 13, wherein the part of the surface of the recording medium that is avoided corresponds to a part of an outermost periphery of the roll of the roll-shaped recording medium held by the holder.

16. The method of controlling according to claim 10, wherein the sensor unit includes an image sensor that optically reads the surface of the recording medium,
the method further comprising:
moving the sensor unit to a state of being in contact with the recording medium and a state of being separated from the recording medium, and
wherein in the obtaining of the information, the information is obtained from the target region in a state where the sensor unit is in contact with the recording medium.

17. The method of controlling according to claim 16, wherein the sensor unit further includes a sensor that detects an electrical signal of an ultrasonic wave passing through the recording medium, and
wherein in the obtaining of the information, the information on the recording medium is obtained based on the electrical signal of the ultrasonic wave detected by the sensor in a state where the sensor unit is brought into contact with the recording medium.

18. The method of controlling according to claim 16, wherein in the estimation, a difference between a feature amount of the information that is obtained and a feature amount corresponding to the type of the recording medium is obtained, and the type in a case where the difference becomes minimum is estimated as the type of the recording medium.

19. A non-transitory computer-readable storage medium storing a program for causing a processor to execute a method of controlling an information processing apparatus, the method comprising:
conveying a recording medium;
obtaining, by a sensor unit, information on the recording medium from the recording medium conveyed in the conveyance;
setting, by the sensor unit, a target region of the recording medium for obtaining the information from the recording medium; and
estimating a type of the recording medium based on the information obtained from the target region of the recording medium,
wherein in the setting, a region in which a part of a surface of the recording medium is avoided is set as the target region by determining a distance for conveying the recording medium, and
wherein in the obtaining, the information is obtained from the target region that is set.
